(19) United States
(12) Patent Application Publication
(10) Pub. No.: US 2005/0114639 A1
(43) Pub. Date: May 26, 2005

(54) Hardened extensible firmware framework to support system management mode operations using 64-bit extended memory mode processors

(76) Inventor: Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/971,824

(22) Filed: Oct. 21, 2004

Related U.S. Application Data
(63) Continuation-in-part of application No. 10/120,865, filed on Apr. 10, 2002.
Application No. 10/120,865 is a continuation-in-part of application No. 09/854,174, filed on May 11, 2001, now Pat. No. 6,848,046.

(51) Int. Cl. G06F 9/00

(52) U.S. Cl. 712/244; 712/227

(57) ABSTRACT

A hardened extensible firmware framework to support system management mode (SMM) operations using 64-bit extended memory mode processors. A firmware-based framework enables drivers to register and load 32-bit and 64-bit event handlers into a hidden memory space (SMRAM). The event handlers may include drivers provided by a platform manufacturer or third parties. In response to an SMM event, the processor is switched to an appropriate execution mode, and the registered event handlers are dispatched in an order until an appropriate handler for the event is identified, at which point that handler is allowed to execute to completion. Under different embodiments, 32-bit and/or 64-bit execution modes may be used to execute corresponding event handlers. During execution, event handler code may seek to access a designated system resource. In response thereto, access to the system resource may be determined based on a security status of the event handler in consideration of any applicable rules defined by a resource access policy.

### RELATED APPLICATIONS

The present application is a continuation-in-part of co-pending application Ser. No. 10/120,865, entitled “HARDENED EXTENSIBLE FIRMWARE FRAMEWORK,” filed on Apr. 10, 2002, which is a continuation-in-part of application Ser. No. 09/854,174, entitled “SMM LOADER AND EXECUTION MECHANISM FOR COMPONENT SOFTWARE FOR MULTIPLE ARCHITECTURES,” filed on May 11, 2001, the benefit of the filing dates for which are claimed under 35 U.S.C. §120.

### FIELD OF THE INVENTION

The field of invention relates generally to computer systems and, more specifically but not exclusively relates to a hardened extensible firmware framework to support system management mode operations on 64-bit extended memory mode processors.

### BACKGROUND INFORMATION

Since the 386SL processor was introduced by the Intel Corporation, System Management Mode (SMM) has been available on IA-32 (Intel Architecture 32-bit) processors as an operation mode hidden to operating systems that executes code loaded by BIOS (Basic Input Output System) or firmware. SMM is a special-purpose operating mode provided for handling system-wide functions like power management, system hardware control, or proprietary OEM— (Original Equipment Manufacture)designed code. The mode is deemed “hidden” because the operating system (OS) and software applications cannot see it, or even access it. IA-32 processors are enabled to enter SMM via activation of an SMI (System Management Interrupt) signal.

Most BIOS implementations that leverage the SMM capability of the foregoing Intel processors simply register a monolithic section of code that is created during the build of the BIOS to support a specific function or set of functions particular to systems that use the BIOS. This code comprises 16-bit assembly in IA-32. The monolithic code segments for these legacy implementations runs from beginning to completion in response to all SMI activations.

In 2003, Advanced Micro Devices (AMD) Corporation, Sunnyvale, Calif., introduced its first 64-bit extended memory mode processor, which provides support for both 32-bit and 64-bit operational modes (as well as a 16-bit real mode). The 64-bit processing mode is commonly referred to as “long-mode,” since it employs longer 64-bit addressing when compared with conventional 32-bit addressing.

In concert with the development of the AMD 64-bit processor, Microsoft Corporation, Redmond, Wash., developed operating systems capable of supporting both 64-bit and conventional 32-bit applications. Current versions of these operating system are called Windows XP professional X64 and Windows 2003 Server X64 (referred to as “X64” operating systems herein for convenience). The X64 operating systems support 32-bit applications on 64-bit hardware using WOW64 (Windows on Windows), which executes in a 32-bit compatibility mode. The X64 operating systems also provide support for 64-bit applications (executed in a 64-bit native mode), which typically comprise existing 32-bit applications that have been recompiled (ported) for 64-bit environments.

Since the late 1990's, Intel® has been developing its own version of an extended memory mode 64-bit processor. Now referred to Intel® Extended Memory 64 Technology™ (EM64T) this extended memory mode architecture represents a natural addition to Intel's ubiquitous IA-32 architecture, allowing platforms to access larger amounts of memory and to support 64-bit integer operations. Additionally, EM64T processors provide a legacy mode (called the “compatibility” that is similar to the AMD 32-bit compatibility mode) that remains fully compatible with today's existing 32-bit applications and operating systems.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an extensible firmware frame that enables various event handlers to be loaded into a hidden memory space and executed in response to an SMI event;

FIG. 2 is a flowchart illustrating the logic used when handling the an SMI event in accordance with a non-hardened extensible firmware framework;

FIG. 3 is a flowchart illustrating the logic used when loading and dispatching execution of an System Management Mode (SMM) Nub that is used to manage event handling when a processor is operating in SMM;

FIG. 4 is a block diagram illustrating various operation and service components of the SMM Nub;

FIG. 5 is a flowchart illustrating operations and logic when loading and registering an event handler in accordance with one embodiment of the invention;

FIG. 6 is a block schematic diagram illustrating details of an event handler image handle table and memory paging map that are used to selectively allow access to system resources based on a corresponding resource access policy;

FIG. 7a is a flowchart illustrating the operations and logic used by one embodiment of the invention when handling an SMI event using separate 32-bit and 64-bit execution modes;

FIG. 7b is a flowchart illustrating operations in logic when handling an SMI event using different sub-modes of a 64-bit extended memory mode, according to one embodiment of the invention;

FIG. 8 is a flowchart illustrating the operations and logic used be a memory access policy to control access to system memory in accordance with one embodiment of the invention;

FIG. 9 is a flowchart illustrating the operations and logic used by an I/O access policy to control access to a system's I/O ports in accordance with one embodiment of the invention; and

FIG. 10 is a schematic diagram of a personal computer system suitable for implementing embodiments of the invention disclosed herein.

### DETAILED DESCRIPTION

Embodiments of methods and apparatus for hardened extensible firmware frameworks to support system management mode operations using 64-bit extended memory mode processors are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the present invention provide mechanisms to support handling of system management events within 64-bit extended memory processor operating modes. In the following descriptions, embodiments of the invention are discussed with referenced to the System Management Mode (SMM) of an Intel IA-32 processor with EM64T. However, this is not meant to be limiting, as the principles and teaching of the invention may be applicable to other processors that provide 64-bit extended memory modes.

An extensible SMM framework has recently become available (e.g., see application Ser. No. 09/854,174 referenced above) that allows for multiple drivers, possibly written by different parties, to be installed for SMM operation. An agent that registers the drivers runs in the EFI (Extensible Firmware Interface) boot-services mode (i.e., the mode prior to operating system launch) and is composed of a CPU-specific component that binds the drivers and a platform component that abstracts chipset control of the SMI signals. The API's (application program interfaces) providing these sets of functionality are referred to as the SMM Base and SMM Access Protocol, respectively.

In conventional SMM implementations, SMM space is often locked by the platform software/firmware/BIOS via hardware mechanisms before handing off control; this grants firmware the ability to abstract the control and security of this binding. In contrast, the software abstraction via the SMM Access protocol provided by the extensible SMM framework obviates the need of users of this facility to know and understand the exact hardware mechanism, thus allowing drivers to be portable across many platforms.

As provided in further detail below, the extensible SMM framework includes the following features: a library in SMM for the drivers' usage, including an I/O access abstraction and memory allocation services; a means to communicate with drivers and applications executing in non-SMM mode; an optional parameter for periodic activation at a given frequency; a means to authenticate the drivers on load into SMM; the ability to close the registration capability; the ability to run in a multi-processor environment where many processors receive the SMI activation; and finally, the capability to run legacy IA-32 SMM code as a distinguished registered event handler. A characteristic of the system is that under one embodiment, 64-bit handlers are run in a 64-bit mode, while running the optional legacy IA-32 handler(s) in a flat 32 mode or using an emulator while operating in the 64-bit mode.

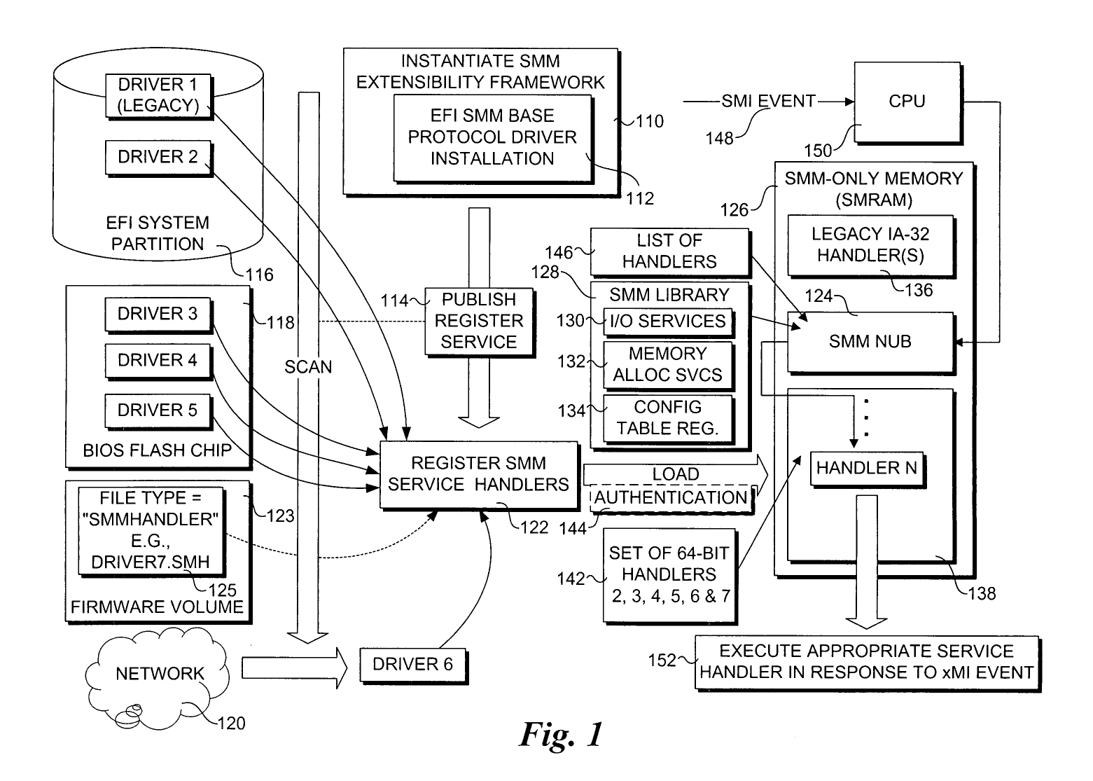

A high-level view of an implementation of an extensible SMM framework is depicted in FIG. 1. The implementation is enabled through use of the EFI framework, which defines a new model for the interface between operating systems and platform firmware. The interface consists of data tables that contain platform-related information, plus boot and runtime service calls that are available to the operating system and its loader. Together, these provide a standard environment for booting an operating system and running pre-boot applications.

The process for producing the SMM extensibility framework is initiated in a block 110, wherein The SMM extensibility framework is instantiated. This includes installing an EFI SMM base protocol driver in a block 112. The EFI SMM base protocol, SMM_BASE, is a CPU-specific protocol that is published by the CPU driver or another agency that can abstract the ISA (Instruction Set Architecture)-specific details of an IA-32-based. Once installed, SMM_BASE publishes an SMM handler register service in a block 114. Publication of the handler register service enables legacy and add-on drivers that are stored on various storage devices, including an EFI system partition 116, a BIOS flash chip 118 and on a storage device accessed via a network 120 to register SMM event handlers in a block 122. In addition to these types of storage devices, the drivers may be stored on other persistent storage devices that are accessible to the computer system in which the invention is implemented, including motherboard-based ROMs, option-ROMs contained on add-on peripheral cards, local hard disks and CD ROMs, which are collectively depicted by a firmware volume 123. (It is noted that EFI system partition 116, BIOS flash chip 118 and the remote storage device on which driver 6 resides also may comprise firmware volumes.) As depicted in FIG. 1, these drivers include a IA-32 legacy (i.e., 32-bit) driver 1 and an add-on driver 2 stored in EFI system partition 116, add-on drivers 3, 4, and 5, which are stored on BIOS flash chip 118, and an add-on driver 6 that is accessed from a remote storage device (e.g., file server) via network 120. As used herein, the term “add-on” corresponds to drivers and firmware files that were not provided with the original firmware of the computer system as provided by the original equipment manufacture (OEM) of that system. Each of drivers 2-6 comprise 64-bit drivers

In an optional mode, the EFI SMM base protocol driver may scan various firmware volumes to identify any drivers that are designated for servicing SMI events via SMM. In one embodiment, these drivers are identified by their file type, such as exemplified by a “DRIVER7.SMH” file 125 corresponding to an add-on driver 7. Add-on driver 7 may comprise a 64-bit driver (as illustrated) or an IA-32 legacy driver.

During the installation of the EFI SMM base protocol driver, an SMM Nub 124 is loaded into SMRAM 126, which comprises an SMM-only memory space. As explained in further detail below, SMM Nub 124 is responsible for coordinating all activities while control is transferred to SMM, including providing an SMM library 128 to event handlers that includes PCI and I/O services 130, memory allocation services 132, and configuration table registration 134.

Registration of an SMM event handler is the first step in enabling the handler to perform a particular SMI event servicing function it is designed to perform. An SMM event handler comprises a set of code (i.e., coded machine instructions) that when executed by the system processor (CPU) performs an event service function in a manner similar to an interrupt service routine. Typically, each SMM event handler will contain code to service a particular hardware component or subsystem, or a particular class of hardware. For example, SMM event handlers may be provided for servicing errors cause by the system's real time clock, I/O port errors, PCI device errors, etc. In general, there may be some correspondence between a given driver and an SMM event handler. However, this is not a strict requirement, as the handlers may comprise a set of functional blocks extracted from a single driver file or object.

When the event handler for legacy driver 1 is registered, it is loaded into SMRAM 126 as a legacy handler 136. As each add-on SMM event handler is registered in block 122, it is loaded into an add-on SMM event handler portion 138 of SMRAM 126; once all of add-on event handlers are loaded, add-on SMM event handler portion 128 comprises a set of event handlers corresponding to add-on drivers 2-7, as depicted by a block 142. In addition, as each SMM event handler is registered, it may optionally be authenticated in a block 144 to ensure that the event handler is valid for use with the particular processor and/or firmware for the computer system. For example, an encryption method that implements a public key may be used. The driver herein would be signed with a private key and the SMM Core would ascertain the public key for the driver via an embedded certificate, etc., and perform the corresponding signature check of the incoming driver. One definition of “trust” herein could be the existence of the signed handler, a corresponding public key in the SMM Core, and the associated signatures matching. As SMM event handlers are registered, they are added to a list of handlers 146 maintained by SMM Nub 124.

Once all of the legacy and add-on SMM event handlers have been registered and loaded into SMRAM 126 and proper configuration data (metadata) is written to SMM Nub 124, the SMRAM is locked, precluding registration of additional SMM event handlers. This system is now ready to handle various SMI events via SMM.

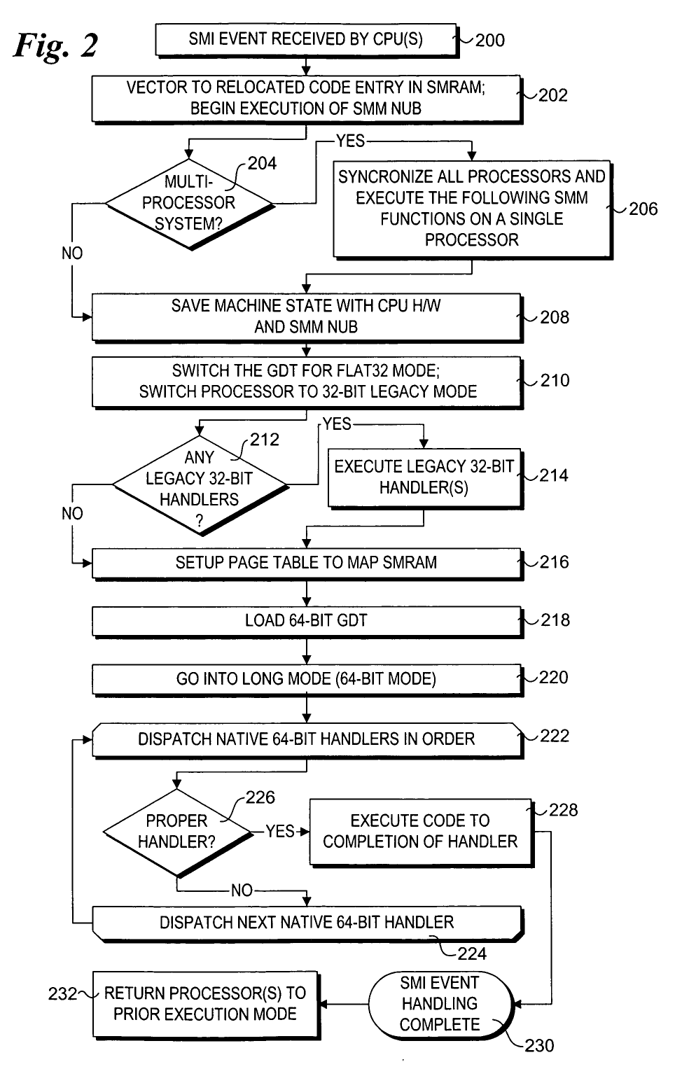

With reference to FIGS. 1 and 2, the process for handling an SMI event with an IA-32 with EM64T processor proceeds as follows: In a block 200, an sMI event signal 148 is received by a CPU 150. In a multiprocessor environment, the SMI event signal is received by each of the processors. In general, for IA-32-based processors, an SMI event may be generated in response to activation of a pin on the system chipset, bus cycle type, or other types of events that cause the processor to enter SMM.

In response to the SMI event, CPU 150 switches to SMM mode and redirects the instruction pointer to the first instruction in SMM Nub 124, wherein the SMM Nub begins executing, as provided by a block 202. In a decision block 204, a determination is made to whether the system is a multiprocessor system. If the answer is yes, all of the processors are synchronized in a block 206, whereby all but a selected processor (e.g., the first processor that is identified during the pre-boot process) are halted while the SMM Nub in the selected processor is executed. The machine state of each CPU is then saved by both the CPU hardware and the SMM Nub 124 in a block 208.

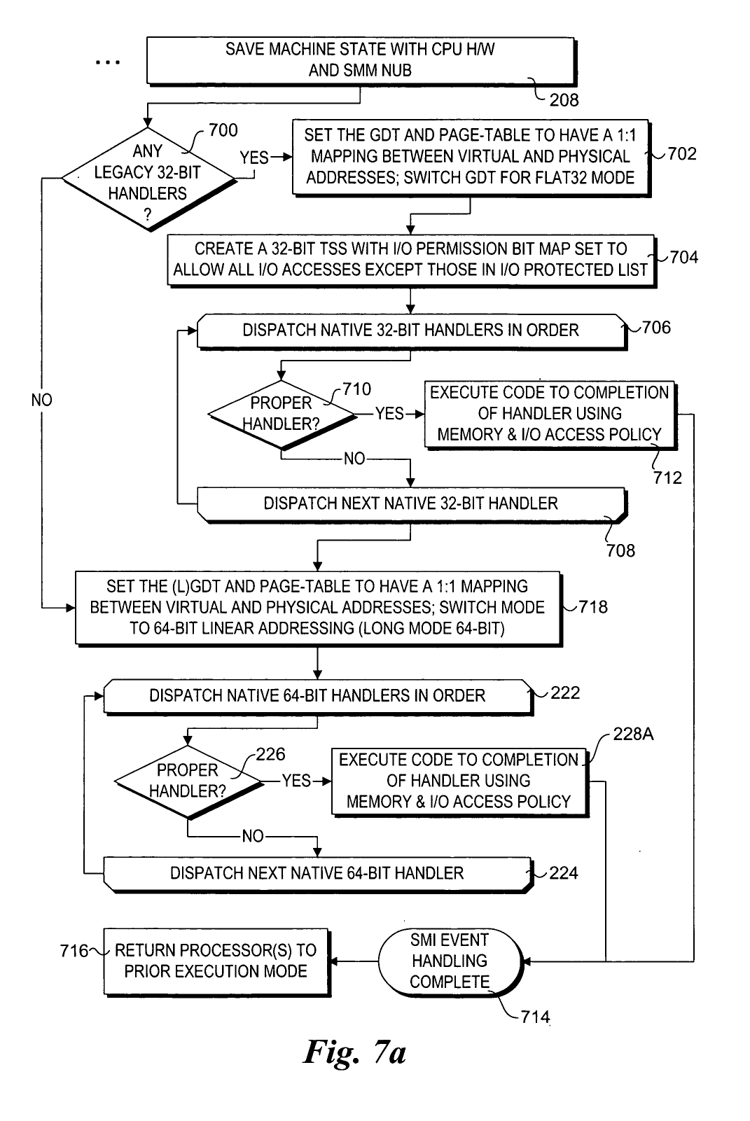

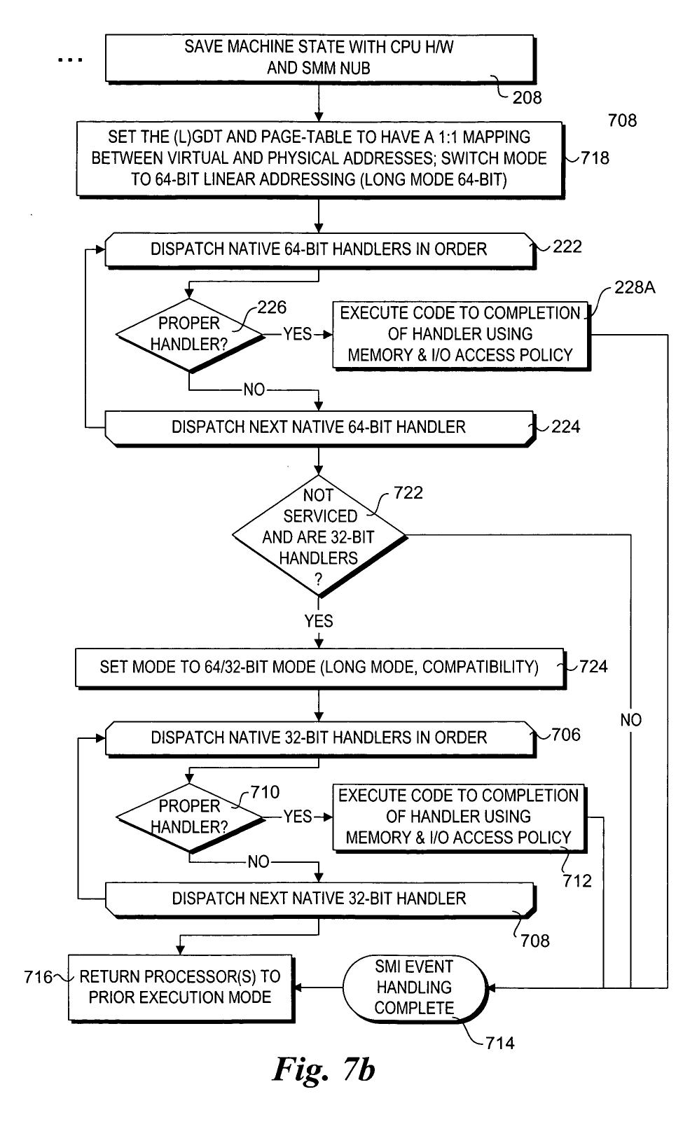

Next, in a decision block 210, the global descriptor table (GDT) is switched to a Flat32 (i.e., 32-bit linear addressing) mode, and the processor mode is switched to a 32-bit legacy mode. The legacy mode comprises a flat 32-bit mode with non-paged 32-bit, zero-based addressing. In one embodiment that supports legacy handlers, a determination is made to whether there are any 32-bit legacy handlers that have been registered and loaded. If there are, the code corresponding to those legacy handlers is executed in a block 214, as described below in further detail with reference to FIGS. 7a and 7b.

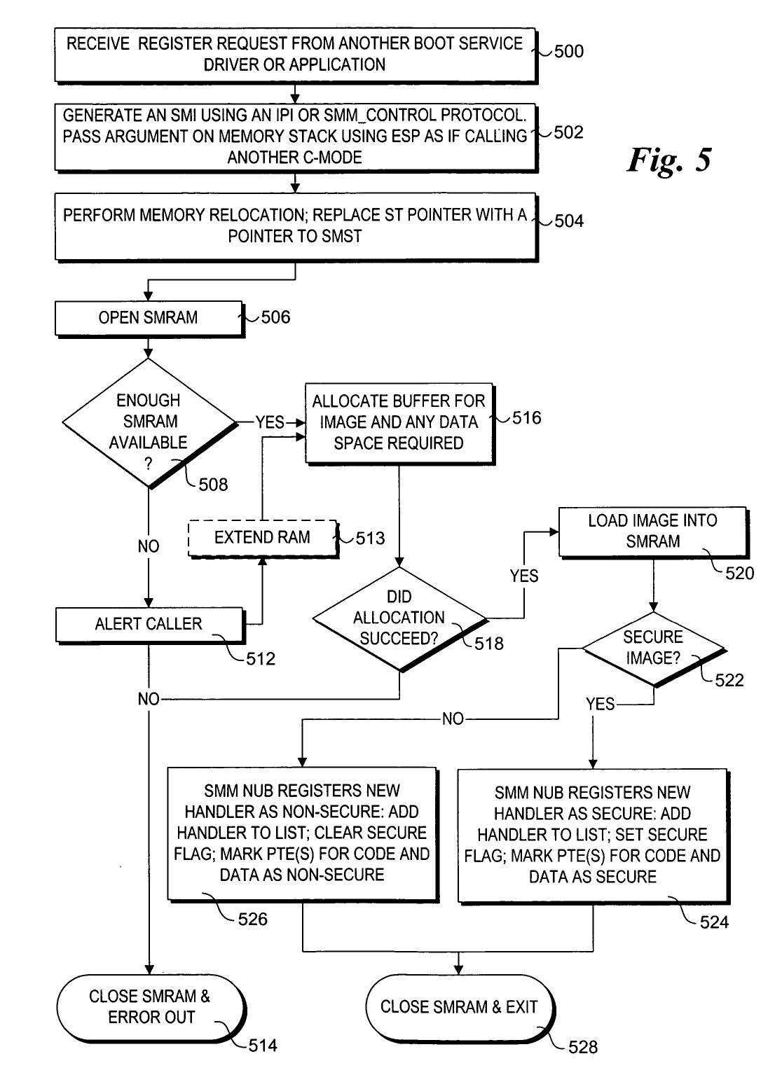

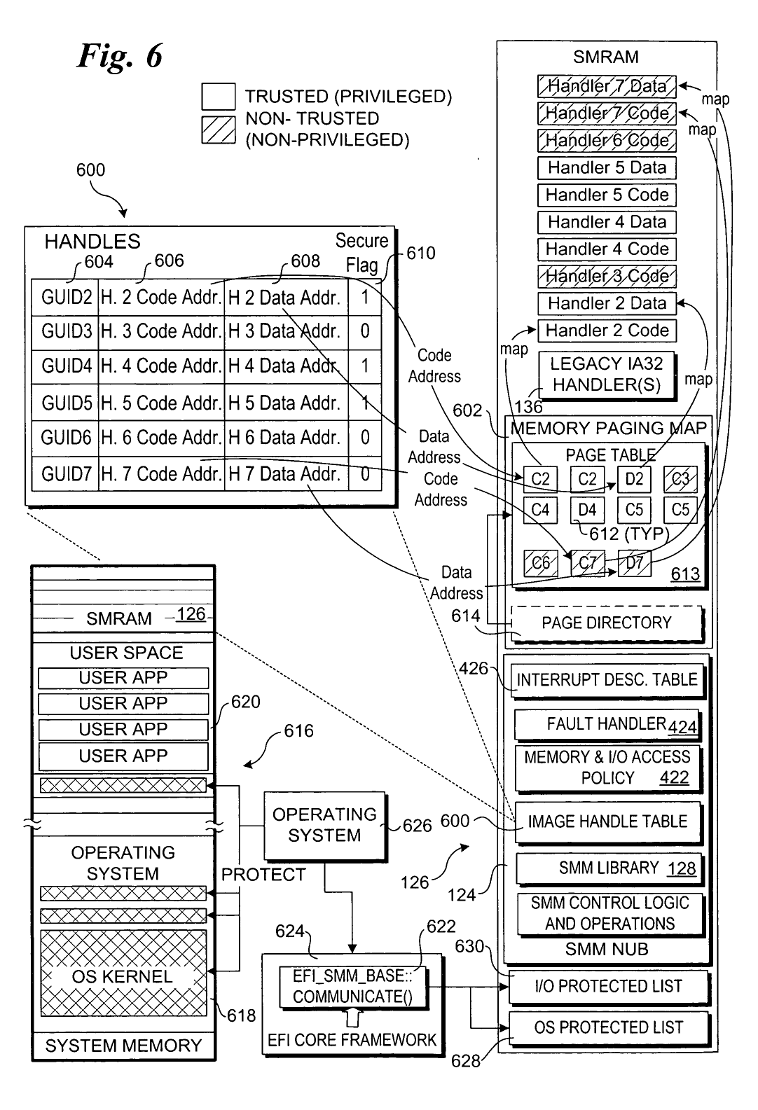

The next set of operations are employed for setting up 64-bit support and executing 64-bit handlers. This begins in a block 216, wherein the page table is set up to map to SMRAM. Further details of this process are discussed below with reference to FIGS. 5 and 6. In a block 218, the 64-bit global descriptor table GDT is loaded. The processor is then switched to long mode (64-bit mode) in a block 220.

Once the execution mode switch has been completed, native 64-bit handlers are dispatched in order until an appropriate event handler is executed to completion to service the SMI event, as provided by start loop and end loop blocks 222 and 224 in FIG. 2 and a block 152 in FIG. 1. In one embodiment, the event handlers are stored as a linked list that is traversed in order from top to bottom, wherein a first event handler is dispatched and additional event handlers are dispatched as needed. Each event handler contains a first portion of code that is used to determine if that handler is the proper handler for servicing the SMI event, as provided by a decision block 226. A typical determination of this sort comprises interrogating the hardware component, subsystem, etc. corresponding to the event handler to see if an error has occurred for that object. If an error has occurred, the event handler is executed to completion in a block 228, whereupon it returns a code to the SMM Nub indicating that it has serviced the SMI event in a return block 230. If the event handler determines that its corresponding device did not cause the error, it returns a code to the SMM Nub indicating such, and the SMM Nub dispatches the next event handler in the list. This process is repeated until the appropriate event handler is executed.

Upon acknowledgment of the SMI event being handled, SMM Nub restores the machine state and executes an appropriate instruction (RSM for IA-32) for the processor/all processors to return the processor(s) to its/their previous processing mode in a block 230.

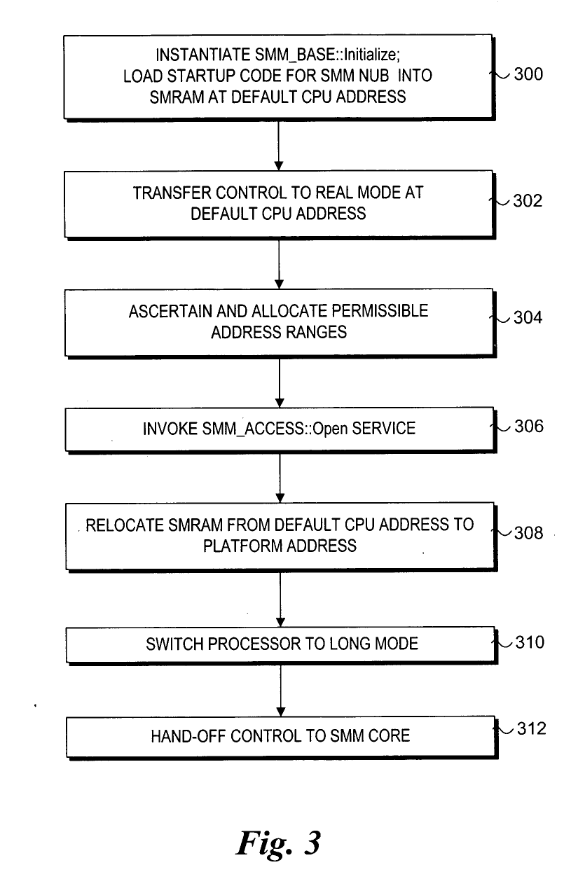

With reference to FIG. 3, the EFI SMM base protocol driver (SMM_BASE) for IA-32 with EM64T processors is installed through the following process. First, an SMM_BASE::Initialize service is called in a block 300. This is implemented with a DXE (Driver Execution Environment) Boot-Service driver that loads and exports this constructor.

In response to instantiating the driver, the startup code for SMM Nub 124 is loaded into SMRAM at the CPU default SMRAM address (0×3000-segment, offset 0×8000) while operating in protected mode. The processor mode is then transferred to real-mode at the execution address 0×38000p in a block 302. Next, in a block 304, the permissible address ranges for the platform's SMRAM implementation is ascertained and allocated. This information may be obtained by calling the SMM_ACCESS::GetCapabilities and SMM_ACCESS::AcquireSmramRange methods with the SMM_BASE::Initialize driver, as described below. If this driver doesn't exist, then the default policy will be 0×A000-seg for IA-32 processors with a default size of 128 Kbyte for IA-32.

After the address range has been allocated, the SMM_ACCESS::Open service is invoked in a block 306 and the initial address for the SMRAM is relocated from the default CPU address (0×38000p) to the platform address in a block 308. The relocated code will include a real-mode component and a protected mode component. The real-mode component will comprise the SMMEntry into the SMRAM relocation address. In a block 310, code is executed to switch the processor to long mode (64-bit) operation. Control is then handed off the SMM core in a block 312.

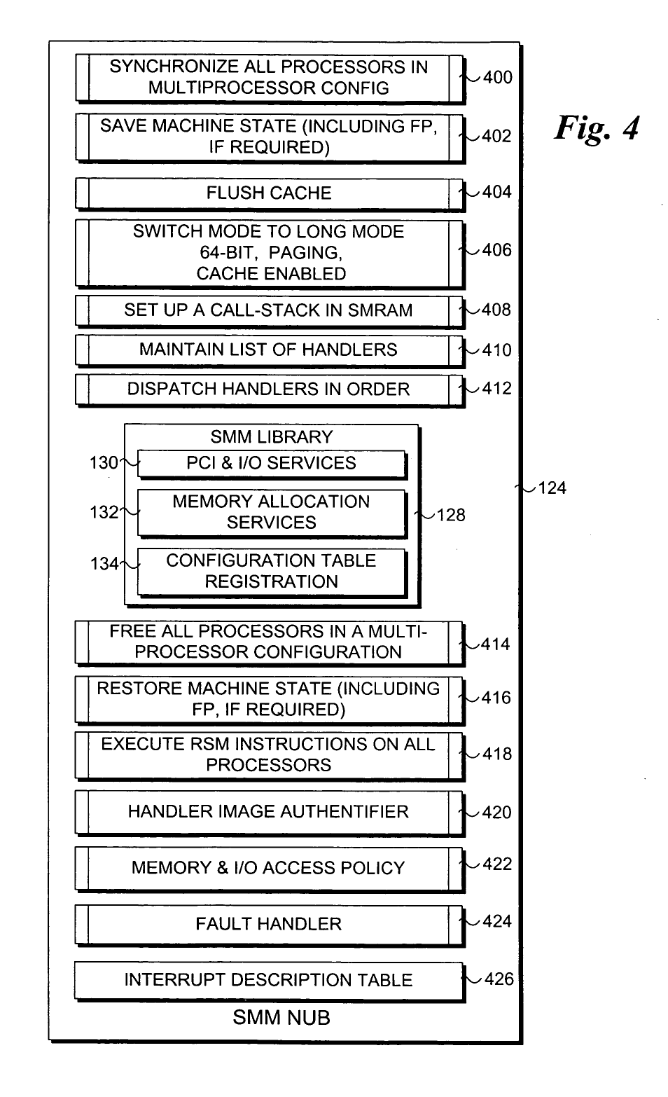

As discussed above, SMM Nub 124 is responsible for coordinating activities while the processor is operating in SMM. The various functions and services provided by SMM Nub 124 are graphically depicted in FIG. 4. These functions and services include synchronizing all of the processors for multiprocessor configurations, saving the machine state, including floating point registers, if required, and flushing the cache, as provided by function blocks 400, 402, and 404. The SMM Nub also provides a mode switching function 406 that switches the processor mode from real mode to long mode, as discussed above with reference to block 310. Mode switching function 406 also enables the processor's paging and internal cache. Other functions provided by SMM Nub 124 include setting up a call-stack in SMRAM 126, maintaining a list of handlers, and dispatching the handlers in order, as depicted by function blocks 408, 410, and 412.

SMM Nub 124 provides a set of services to the various event handlers through SMM library 128, including PCI and I/O services 130, memory allocation services 132, and configuration table registration services 134. In addition, SMM Nub 124 provides several functions that are performed after the SMI event is serviced. If the computer system implements a multiprocessor configuration, these processors are freed by a function 414. A function 416 restores the machine state of the processor(s), including floating point registers, if required. Finally, a function 418 is used to execute RSM instructions on all of the processors in a system.

In one embodiment, the SMM Nub includes four additional components. These components include a handler image authenticator 420, a Memory and I/O access policy 422, a fault handler 424, and an Interrupt Description Table (IDT) 426. As described below in further detail, these components are involved in hardening the extensible SMM framework by working in cooperation with other SMM components to prevent untrustworthy SMM handlers from accessing memory and I/O resources that are marked to be protected from such access.

As discussed above, the extensible SMM framework provides two mechanisms for loading event handlers: (1) driver-based installation; and (2) autonomous load from the firmware volumes. For driver-based installations, the SMM_BASE protocol shall be installed by a driver that is loaded by the DXE dispatcher. After the SMM_BASE protocol is installed, it publishes an interface that enables event handlers to be registered and loaded. The protocol for registration is described by the EF11.0 specification, which defines a mechanism for publishing new callable interfaces in the EFI environment. The SMM_BASE protocol publication essentially comprises exposing the API described in the SMM-CIS (the SMM “Component Interface Specification,” or EF11.10 document describing the EF11.10 Protocol or API set that abstracts this registration mechanism in the pre-boot space) with the EFI core. The EFI core maintains a protocol database of GUID/interface pointer pairs. The GUID comprises a 128-bit globally-unique ID of the interface, while the Interface pointer points to an interface definition that further defines the functions provided by each EFI components.

Through this mechanism, any driver that wishes to install event handlers, wherein in one embodiment an event handler is some code that can be a 64-bit executable containing instructions corresponding to the IA-32 with EM64T instruction set, or legacy 32-bit handlers (containing instructions corresponding to the conventional IA-32 instruction set), can use the standard mechanism of EF11.0 to discover the SMM_BASE protocol instance (via the core service “LocateProtocol”) or register a notification with the EFI core to be alerted when the SMM_BASE protocol is installed. In either case, once the SMM_BASE protocol is installed, various drivers can marshal the interface pointer to the SMM_BASE instance (via the EF11.0 “HandleProtocol service”) and then invoke the SMM_BASE::Register service. The binary code that the driver consuming the SMM_BASE service uses can be ascertaining from its own driver image, a file from disk or network. In one embodiment, the 64-bit and optional 32-bit handlers are written to be compliant with the PE32+ (Portable Executable 32-bit) binary object file format. The file can be in the firmware volume or on the FAT disk partition. Registration of event handlers is further facilitated by an SMM_BASE::Register service. This service comprises a DXE Boot-Service driver that permits registration of an event handler.

With reference to FIG. 5, the process for registering an SMI event handler begins in a block 500, wherein a request to register an event handler is received by the SMM_BASE protocol driver from another boot service driver or application (e.g., drivers 1-7). In response, an SMI is generated in a block 502, using an IPI or SMM_CONTROL protocol. The argument is passed on the memory stack using the ESP memory stack pointer as if calling another handler. In one embodiment, the handlers may be written in C, with the generated image corresponding to the PE32+ format. Next, in a block 504, memory relocation is performed and the ST (System Table from EF11.0) pointer is replaced with a pointer to the SMST (System Management System Table).

Next, the SMRAM is opened in a block 506 using the SMM_ACCESS::Open service, which is access through the SMM_ACCESS protocol. Further details of SMM_ACCESS protocol are provided in the APPENDIX that follows. The SMM_ACCESS::Open service abstracts programming of the memory controller to enable visibility of the SMRAM from non-SMRAM based code. This enables the SMM_BASE protocol to copy and install code, such as the SMM Nub, into SMRAM.

Next, in a decision block 508 a determination is made to whether enough SMRAM is available to hold the event handler routine and any additional memory space the routine may require during its operation. If not enough SMRAM memory space is available, the logic proceeds to a block 510 in which the caller is alerted. As an option, in response to being alerted, the caller may use the SMM_ACCESS::GetCapabilities and SMM_ACCESS::AcquireSmramRange method to acquire additional memory space within the SMRAM. If there is not enough SMRAM memory space available, the SMRAM is closed by calling the SMM_ACCESS::Close method and an error code is returned to the caller in an error return block 514.

If it is determined that there is enough SMRAM memory space available, a memory buffer for the SMRAM image of the handler is allocated in a block 516. A determination to whether the allocation succeeded is made in a decision block 518. If the allocation wasn't successful, the logic proceeds to error return block 514. If the allocation is successful, an image of the event handler is loaded into the SMRAM memory space that had been previously allocated in a block 520.

In accordance with SMM framework hardening aspects of the invention, an optional memory access mechanism is provided that prevents event handlers that are deemed to be non-secure (i.e., non-trusted)) from accessing memory allocated to and/or by trusted code. Generally, this trusted code may include the SMM Nub in the SMRAM, and trusted code in other portions of the systems main memory, such as EFI core components and an operating systems kernel. In one embodiment, the trusted code may include event handlers that are deemed as secure.

In one embodiment, a “gatekeeper” mechanism that controls memory access while operating in SMM mode is used to implement the foregoing memory access scheme. With reference to FIG. 6, the gatekeeper mechanism uses data contained in an image handle table 600 in conjunction with a memory paging map 602 to define which portions of SMRAM memory are privileged and non-privileged. In general, memory corresponding to trusted SMM components will be privileged, while memory corresponding to non-trusted components will be deemed as non-privileged.

Image handle table 600 includes multiple rows of data, wherein each row contains data pertaining to a respective event handler image. In one embodiment, the table includes a GUID (global unique identifier) column 604, a handler address code address column 606, a handler data address column 608, and a secure flag column 610. Upon registration of an event handler image with the SMM core, a GUID is assigned to the image and stored in GUID column 604. The GUID provides a “handle” for accessing its associated event handler. The address of the first instruction corresponding to a given event handler image is stored in handler address code address column 606. Similarly, the address corresponding to a base memory location of any memory that was allocated for data purposes for the event handler is stored in handler data address column 608. A Boolean flag identifying whether an event handler is deemed to be secure or non-secure is stored in column 610. In one embodiment, image handle table 600 also is used to store list of handlers 146. In one embodiment, the data contained in image handler table 600 are stored in a linked list.

In one embodiment, memory paging map 602 is configured to include multiple page table entries 612 in a page table 613 that are used to map the SMRAM address space used to store the event handler images and any corresponding memory that has been allocated for data purposes. The PTEs may also be used to map out the portion of SMRAM occupied by other SMRAM components, including SMM Nub 128. In general, memory-paging map 602 may be configured to correspond to a portable (i.e., processor architecture independent) memory paging scheme, such as the PMAP memory paging scheme developed for the MACH micro-kernel at Carnegie Mellon University in the late 1980's, or similar portable memory paging schemes used in various modern operating systems. Optionally, the memory-paging scheme may be particular to the type of processor being used to support SMM operations. For example in one embodiment, the memory-paging scheme may also implement a page directory 614 in addition to page table 613.

In one embodiment, each page table entry includes indicia that identifies whether the memory page corresponding to the PTE holds privileged or non-privileged memory. Typically, the indicia may include data defined by one or more bits contained in the PTE. For example, in one embodiment a Supervisor/User bit is set in the PTE to indicate that the page holds privileged memory, and cleared if the page holds non-privileged memory.

Returning to the flowchart of FIG. 5, the next portion of the flowchart pertains to hardening the SMM framework. First, a determination is made to whether the image corresponds to a secure (i.e., trustworthy) event handler in a decision block 522. In one embodiment, this determination is made by handler image authenticator 420, which attempts to authenticate the event handler via a digital signature. In general, the digital signature scheme should ensure that any event handler image that has been altered since it was originally signed by its developer will be identified as invalid. In one embodiment of the invention, the digital signature is based on the public key infrastructure X.509 V3 standard. Handler image authenticator 420 may store the public key using one of several well-known encryption techniques to perform the signature check.

If the image is determined to be secure, the logic proceeds to a block 524 in which the SMM Nub registers the event handler as a secure handler. In one embodiment, this comprises adding an entry in image handle table 600, setting the Boolean value in secure flag 610 column to “1”, and marking any page table entries (PTEs) corresponding to memory pages allocated to the event handler image and any data pages allocated to the event handler as privileged.

If the image is determined to be non-secure, the logic proceeds to a block 526 in which the SMM Nub registers the event handler as a non-secure handler. In accordance with the foregoing embodiment this comprises adding in entry in image handle table 600, setting the Boolean value in secure flag 610 column to “0”, and marking any page table entries (PTEs) corresponding to memory pages allocated to the event handler image and any data pages allocated to the event handler as non-privileged. After completion of the operations in either of blocks 524 or 526 the logic proceeds to a return block 528 in which SMRAM is closed and the procedure exits.

In one embodiment, the memory access protection scheme may be extended into the run-time environment, such that gatekeeper operations are performed to allow or deny access to memory contained in the non-SMRAM portion of the system memory. A typical system memory configuration 616 is shown in FIG. 6, which includes an operating system space 618, a user space 620 in which code and data corresponding to user applications are stored, and an SMRAM space 126. For simplicity, each of operating system space 618 and user space 620 are shown as contiguous; in actual use, these spaces may typically comprise non-contiguous portions of the system memory.

In many modern operation systems, memory is segregated into privileged and non-privileged portions. Typically, privileged memory may only be accessed by the operating system, while non-privileged memory may be accessed by the OS or user applications. In accordance with this scheme, one embodiment of the invention provides a mechanism to enable protection of the operating system's privileged memory, while enabling secure event handlers to access non-privileged memory. In one embodiment, this protection mechanism is enabled through use of an EFI_SMM_BASE::Communicate() method 622 provided by an EFI core framework 624, which allows an operating system 626 to define a list of memory pages or ranges to deny access to, and store the list in the SMRAM, or make the location of the list known to the SMM Nub (e.g., through a pointer) so that it can be retrieved while in SMM. In one embodiment, the list of pages or ranges is stored as a linked list in SMRAM 126, as depicted by an OS protected list 628 in FIG. 6.

In accordance with further aspects of the invention, a mechanism is also provided to enable selected I/O ports to be protected. Generally, the decision on which I/O ports to protect may be made by EFI core framework 624, or by operating system 626. In a manner similar to that described above, the EFI core framework or the OS, as applicable, invokes the EFI_SMM_BASE::Communicate() service 622 to store an I/O protected list 630 in SMRAM 126. As before, the I/O protect list may also be stored outside of SMRAM, wherein the location of the list is passed to the SMM Nub.

With reference to FIG. 7A, in accordance with one embodiment of the invention, the following operations are performed in response to an SMI event. Initially, operations provided in blocks 200, 202, 204, 206 (not shown in FIG. 7A), and 208 are performed in a manner similar to that discussed above with reference to FIG. 2. Next, in a block 700, a determination is made to whether any legacy 32-bit handlers are registered. If so, the logic proceeds to a block 702, wherein the GDT and the page-table are set to have a 1:1 mapping between virtual and physical addresses. In one embodiment in accordance with a built-in hardware scheme supported by IA-32 processors, this can be accomplished by programming register CR3 with the location of page directory 614 and enabling paging by setting the “PG” (paging) and “PE” (paging enable) bits in register CR0 to “1.” If a software-based paging mechanism is used, the paging translations will be handled by mapping physical address into appropriate page and offset values that will depend on the internal partitioning invoked by the paging mechanism. The general principle is to set up a memory access mode that uses the paging information defined in memory paging map 602, whether that information is implemented via hardware or software. The GDT is also switched for flat32 mode.

As discussed above, one may want to protect access to selected I/O ports. In one embodiment corresponding to IA-32-based processors, a TSS (Task State Segment) is created in a block 704 with its I/O permission bit map set to allow access to all I/O ports except those in I/O protected list 630. In many processors, I/O ports are mapped to the memory address space, and the protection of the I/O ports are handled in the similar manner to that discussed herein with respect to memory protection.

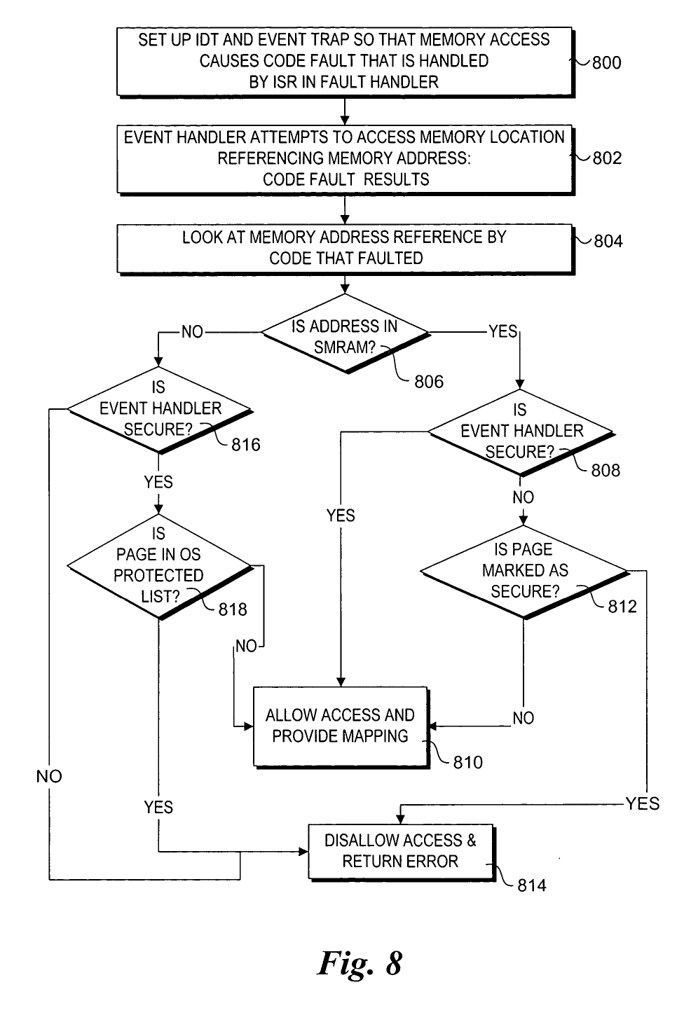

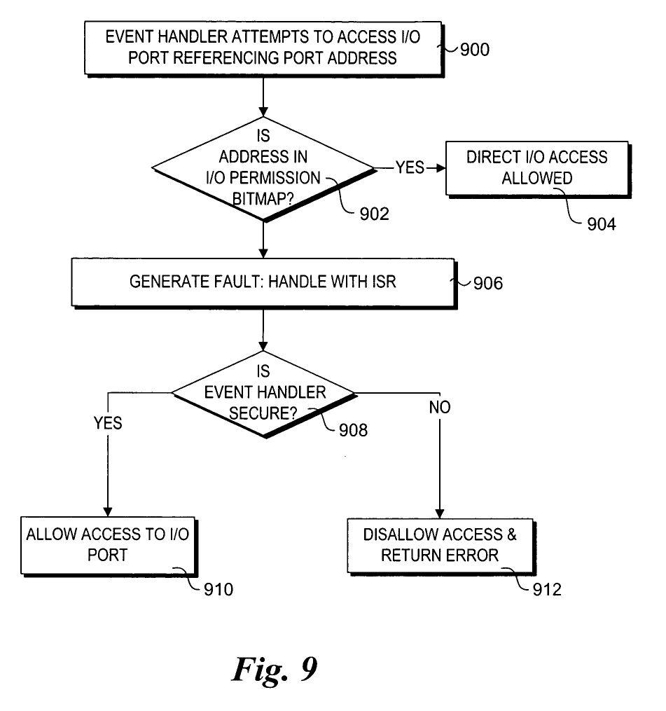

At this point, the processing proceeds in a similar manner to that discussed above for the conventional SMM event handler dispatching, except that the memory and I/O protection mechanisms are now enabled, as indicated by blocks 712 and 228A. Event handler operations when the memory protection is enabled in accordance with one embodiment of the invention are shown in FIG. 8. Event handler operations when the I/O protection is enabled in accordance with one embodiment of the invention are shown in FIG. 9.

In further detail, the processing of 32-bit legacy handlers are similar to the processing of 64-bit handlers discussed above with reference to FIG. 2. As depicted by start and end loop blocks 706 and 708, the native 32-bit legacy handlers are dispatched in order until a proper handler (corresponding to the SMI event) is identified in a decision block 710. If the answer to decision block 710 is YES, that handler is executed to completion using the memory and I/O access policy discussed below, as depicted in a block 712. Upon completion of the handler, indicia identifying that the SMI event handling has been completed is returned in accordance with a return block 714 and the processor(s) is/are returned to their prior execution mode in a block 716.

If either the answer to decision block 700 is NO or none of the 32-bit legacy handlers that are dispatched is the proper handler, the logic proceeds to a block 718. As before, the GDT and page table are set to have a 1:1 mapping between virtual and physical addresses. The processor is also switched to 64-bit linear addressing mode (long mode). Depending on the location of the 64-bit handlers, the GDT may or may not point to an address above 4 Gbytes. For addresses above 4 Gbytes, the GDT is sometimes referred to as the LGDT (long GDT).

Switching to long mode includes several steps. In general, the sequence involves disabling paging (CR0.PG=0), enabling physical-address extensions (CR4.PAE=1), loading CR3, enabling long mode (EFER.LME=1), and re-enabling paging (CR0.PG=1). Specifically, the following sequence is employed to activate long mode:

1. If starting from page-enabled protected mode, disable paging by clearing CR0.PG to 0. This requires the MOV CR0 instruction used to diable paging be located in an identity-mapped page (e.g., 1:1 virtual-to-physical address mapping).

2. In an order:
Enable physical-address extensions by setting CR4.PAE to 1. Long mode requires the use of physical-address extensions (PAE) in order to support physical-address sizes greater than 32 bits. Physical-address extentions must be enabled before enabling paging
Load CR3 with the physical base-address of the level-4 page-map-table (PML4).
Enable long mode by setting the long-mode enable control bit (EFER.LME) to 1.

Following the operations of block 718, the operations of blocks 222, 224, and 226 are performed in the manner discussed above for like-numbered blocks in FIG. 2. Upon identification of an appropriate handler, the handler code is executed to completion using the memory and I/O access policy discussed below, as depicted in a block 228A. At the completion of the handler, the logic continues to return block 714 and block 716.

In one embodiment, the 64-bit extended memory mode is employed for executing both 64-bit native handlers and 32-bit legacy handlers, with the latter being executed using a built-in compatibility mode. In further detail, the 64-bit extended memory mode (i.e., long mode) has two sub-modes: (1) 64-bit, which executes instructions coded for 64-bit addressing; and (2) compatible mode, which executes instructions coded for 32-bit addressing.

The operations corresponding one implementation of this embodiment are shown in FIG. 7b, wherein blocks sharing reference numbers with those shown in FIG. 7a perform similar operations to those described above for the blocks. Overall, the processes illustrated in FIGS. 7a and 7b are similar, except they differ with respect to the order the 64-bit and 32-bit handlers are dispatched, and the processor modes used to execute the handlers.

More specifically, the embodiment of FIG. 7b switches to long mode 64-bit processing in block 718, and then dispatched the 64-bit handlers in order until a proper handler is identified. If the SMM event is not serviced by one of the 64-bit handlers, and one or more 32-bit handlers have been registered, as determined by a decision block 722, the process proceeds to a block 724. In this block, the operating mode of the process is switched to long mode, compatibility mode, which supports execution of 32-bit code while in the long mode. The long mode sub-modes are selected by setting two code-segment-descriptor bits, CS.L and CS.D. For the 64-bit mode, CS.L=1 and CS.D=0. For the compatibility mode, 32-bit operand and address size, CS.L=0 and CS.D=1. After the processing mode has been switched to long mode, compatibility mode, any native 32-bit handlers are dispatched in order until a proper handler is identified, at which point that handler is allowed to continue execution until completion.

With reference to the flowchart of FIG. 8, during SMM configuration operations interrupt description table 426 is set up so that memory accesses causes a code fault that is handled by a corresponding interrupt service routine (ISR) in fault handler 424, as depicted by a block 800. Beginning with a block 802, the following operations and logic are performed in response to a memory access while in SMM. In block 802, an event handler attempts to access a memory location, which results in a code fault. This invokes the ISR in fault handler 424, which uses a memory access policy defined in memory and I/O access policy component 422 to handle the fault condition.

First, in a block 804, the address of the code that faulted is examined. This address corresponds to the physical address (i.e., location) of the memory that was attempted to be accessed. In a decision block 806 a determination is made to whether the memory address corresponds to an SMRAM memory address. If the answer is YES, the logic proceeds to a decision block 808 in which a determination is made to whether the event handler attempting the memory access is secure. In one embodiment, this can be ascertained by examining the value corresponding to secure flag column 610 for the event handler. If the event handler has been deemed secure, the logic proceeds to a block 810 in which the memory access is allowed, and an appropriate mapping to the memory address is provided.

If the answer to decision block 808 is NO, a determination is made in a decision block 812 to whether the memory page corresponding to the memory address is marked as secure (i.e., privileged). If it has not, then the operations in block 810 are performed in the manner discussed above. If the memory page is marked as secure, access to the memory is disallowed and an error code is returned to the handler, as depicted by a block 814.

If the memory address doesn't correspond to memory contained in the SMRAM, the answer to decision block 806 is NO, causing the logic to proceed to a decision block 816 in which a determination is made to whether the event handler is secure. If the event handler is not secure, the logic flows to decision block 814, thereby denying access to the memory. If the event handler is secure, the logic proceeds to a decision block 818 in which a determination is made to whether the memory page corresponding to the memory address is a memory page contained in OS protected list 630. As discussed above, in an optional embodiment, OS protected list 630 comprises a list of address ranges rather than memory pages. In this case, a determination would be made to whether the memory address falls within one of the address ranges contained in the OS protected list. If the address falls within a page or address range that is marked as protected, the logic proceeds to block 814, denying access to the memory. If the memory address corresponds to an unprotected portion of memory, the logic proceeds to block 810, wherein access to the memory is allowed.

The foregoing is illustrative of just one potential memory access policy. The actual policy used may be determined on the particularities of the implementation. For example, it may be desired to block access to any memory that is not in SMRAM, regardless of whether the event handler requesting access is secure or not. In another implementation, a secure memory handler could be provided access to all memory.

In general, for processors that map I/O ports to memory addresses, the operations performed in the flowchart of FIG. 8 may be implemented to allow or deny access to I/O ports in a similar manner described above for protecting memory access. However, in this instance, if access is allowed, an I/O port corresponding to the memory address would be accessed, rather than a memory location.

With reference to FIG. 9, an I/O access protection scheme that uses an I/O protection mechanism operates as follows. Under one embodiment, an I/O permission bitmap is defined via a data structure managed by the SMM Nub. The process begins in a block 900, wherein an event handler attempts to access an I/O port referencing its port address. In accordance with a decision block 902, a determination is made to whether the port address is one of the port addresses that permission to access is allowed for as defined by the I/O permission bitmap. In practice, the result of this decision are performed by logic contained in an SMM Nub function or procedure coded for such purposes. If the answer to decision block 902 is YES, direct access to the I/O port is allowed, as depicted by a block 904.

In the event that a request to access an I/O port having a port address that is not included in the I/O permission bitmap is performed, a code fault will be generated in a block 906. In one embodiment, the code fault will then be handled by an ISR stored in fault handler 424 using the following operations and logic. In a decision block 908, a determination is made to whether the event handler is secure. If it is secure, access to the I/O port is allowed in accordance with a block 910. If not, access to the I/O port is disallowed, and an error code is returned to the event handler in a block 912.

Exemplary Machine for Implementing Embodiments of the Invention

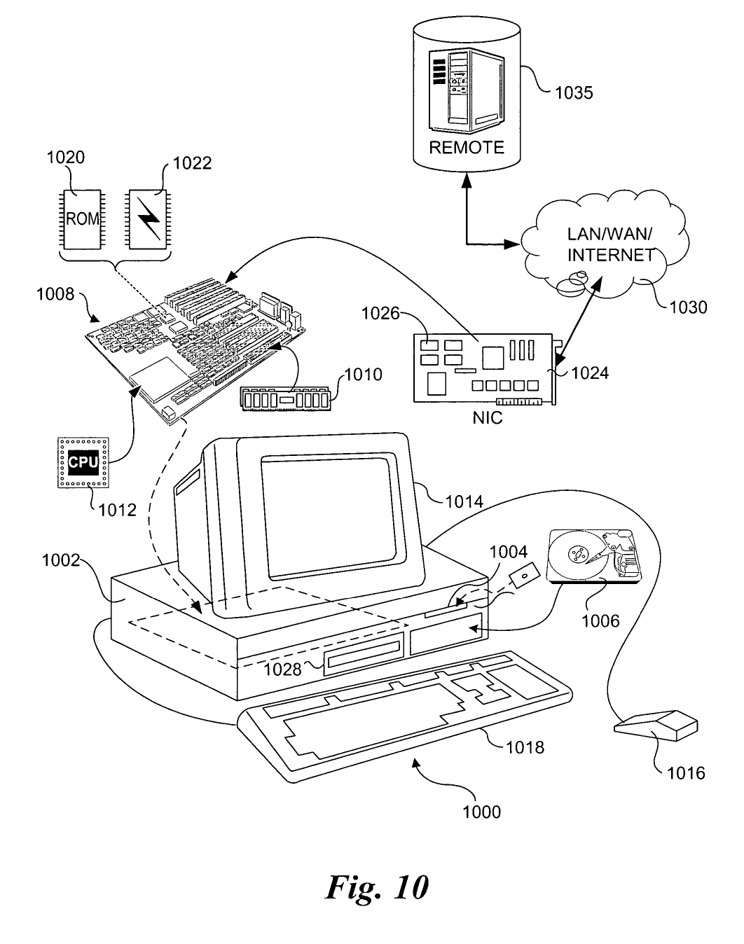

FIG. 10 illustrates an embodiment of an exemplary computer system 1000 to practice embodiments of the invention described above. Computer system 1000 is generally illustrative of various types of computer devices, including personal computers, laptop computers, workstations, servers, etc. For simplicity, only the basic components of the computer system are discussed herein. Computer system 1000 includes a chassis 1002 in which various components are housed, including a floppy disk drive 1004, a hard disk 1006, a power supply (not shown), and a motherboard 1008. Hard disk 1006 may comprise a single unit, or multiple units, and may optionally reside outside of computer system 1000. The motherboard 1008 includes a memory 1010 coupled to one or more processors 1012. Memory 1010 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 1012 is illustrative of a processor that supports a 64-bit extended memory mode, such as, but not limited to an Intel IA-32 processor with EM64T or an AMD 64-bit Opteron or Athlon processor.

The computer system 1000 also includes one or more non-volatile memory devices on which firmware is stored. Such non-volatile memory devices include a ROM device 1020 or a flash device 1022. Other non-volatile memory devices include, but are not limited to, an Erasable Programmable Read Only Memory (EPROM), an Electronically Erasable Programmable Read Only Memory (EEPROM), or the like. The computer system 1000 may include other firmware devices as well (not shown).

A monitor 1014 is included for displaying graphics and text generated by firmware, software programs and program modules that are run by computer system 1000, such as system information presented during system boot. A mouse 1016 (or other pointing device) may be connected to a serial port, USB (Universal Serial Bus) port, or other like bus port communicatively coupled to processor 1012. A keyboard 1018 is communicatively coupled to motherboard 1008 in a similar manner as mouse 1016 for user entry of text and commands. In one embodiment, computer system 1000 also includes a network interface card (NIC) or built-in NIC interface (not shown) for connecting computer system 1000 to a computer network 1030, such as a local area network (LAN), wide area network (WAN), or the Internet. In one embodiment, network 1030 is further coupled to a remote computer 1035, such that computer system 1000 and remote computer 1035 can communicate. In one embodiment, a portion of the computer system's firmware is loaded during system boot from remote computer 1035.

The illustrated embodiment further includes an optional add-in card 1024 that is coupled to an expansion slot of motherboard 1008. In one embodiment, add-in card 1024 includes an Option ROM 1026 on which firmware is stored. Computer system 1000 may also optionally include a compact disk-read only memory (“CD-ROM”) drive 1028 into which a CD-ROM disk may be inserted so that executable files, such as an operating system, and data on the disk can be read or transferred into memory 1010 and/or hard disk 1006. Other mass memory storage devices may be included in computer system 1000.

Thus, embodiments of this invention may be used as or to support software/firmware components and/or programs executed upon some form of processing core (such as the CPU of a computer) or otherwise implemented or realized upon or within a machine-accessible medium. A machine-accessible medium includes any mechanism for storing or transmitting information in a form readable by a machine (e.g., a computer). For example, a machine-accessible medium can include such as a read only memory (ROM); a random access memory (RAM); a magnetic disk storage media; an optical storage media; and a flash memory device, etc. In addition, a machine-accessible medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1. A method, comprising:
providing a mechanism to enable loading of a 64-bit event handler into a hidden memory space for the computer platform, the computer platform including a 64-bit extended memory mode processor that supports execution of 32-bit and 64-bit code; and
in response to a system management event;
switching the processor into a 64-bit execution mode; and
executing the 64-bit event handler to service the system management event.

2. The method of claim 1, wherein the mechanism to enable loading the 64-bit event handler comprises:
providing an abstracted interface that enables a set of machine code corresponding to an event handler that is stored outside of any component(s) in which the original set of firmware is stored to be loaded into the hidden memory space;
redirecting an instruction pointer for the processor to execute the set of machine code to service the system management event while the processor is operating in the 64-bit execution mode.

3. The method of claim 2, wherein the abstracted interface is published during a pre-boot process for the computer platform to enable a driver to load the set of machine code corresponding to the event handler prior to loading an operating system for the computer platform.

4. The method of claim 1, wherein the mechanism for enabling loading of the 64-bit event handler comprises:
scanning for any firmware volumes that are materialized during a pre-boot process for the computer system to identify an existence of any firmware file containing an event handler that is compatible with the hidden execution and storage mode of the processor;
loading the event handler into the hidden memory space;
redirecting an instruction pointer for the processor to execute the event handler to service the event while the processor is operating in the 64-bit execution mode.

5. The method of claim 1, further comprising:
loading an event handler management service into the hidden memory space;
registering one or more event handlers with the event handling management service;
loading said one or more event handlers into the hidden memory space;
redirecting an instruction pointer for the processor to begin execution of the event handler management service is response to the event; and
dispatching an event handler via the event handler management service to service the event.

6. The method of claim 5, wherein a plurality of event handlers are registered with the event handling management service and loaded into the hidden memory space, further comprising:
creating an ordered list of said plurality of event handlers;
dispatching a first event handler;
determining if the first event handler is an appropriate event handler for servicing the event and, if it is, executing the first event handler to completion to service the event; otherwise
dispatching a next event handler in the list and determining whether that event handler is an appropriate event handler and repeating this function until the appropriate event handler has been dispatched, whereupon that event handler is executed to completion to service the event.

7. A method for claim 6, wherein each of said plurality of event handlers comprise a set a machine code that is executed by the processor to service an error condition generated by a hardware component in the computer platform that causes the event, and the operation of determining whether an event handler is the appropriate event handler for servicing the event comprises:
executing a first portion of the set of machine code corresponding to the event handler that was most recently dispatched that queries the hardware component corresponding to that event handler to determine if the error condition was caused by that hardware component; and
completing execution of the set of machine code for the event handler if it is determined that the error condition was cause by its corresponding hardware component, otherwise returning a value to the event handler management service indicating that the event handler is not the appropriate event handler to service the error condition.

8. The method of claim 5, further comprising authenticating an event handler before it is loaded into the hidden memory space.

9. The method of claim 5, wherein an original set of firmware for the computer platform includes one or more legacy 32-bit event handlers, the method further comprising:
registering said one or more legacy event handlers with the event handling management service;
loading said one or more legacy event handlers into the hidden memory space; and
dispatching at least one of said one or more legacy event handlers via the event handler management service to service the event.

10. The method of claim 5, wherein the computer system includes a plurality of processors, further comprising:
loading the service handler management service into a selected processor among said plurality of processors;
causing the selected processor to begin execution of the service handler management service in response to the event;
synchronizing all of said plurality of processors other than the selected processor and halting execution of a respective current operation for each of these other processors during execution of the service handler management service;
returning all of said plurality of processors to a previous processing mode to resume execution of their respective operations after the event has been serviced by an appropriate event handler.

11. The method of claim 1, further comprising:
defining a resource access policy that defines rules to allow or disallow access to a designated system resource;
determining a security status of the event handler; and
allowing access to the designated system resource in response to a corresponding access request during execution of the event handler based on the security status of the event handler and the resource access policy.

12. The method of claim 11, wherein the resource access policy corresponds to a memory access policy that allows or disallows access to selected portions of a computer platform's memory resources.

13. The method of claim 11, wherein the resource access policy corresponds to an input/output (I/O) port access policy that allows or disallows access to a computer platform's I/O ports.

14. A method, comprising:
providing a mechanism to enable loading of 32-bit and 64-bit event handlers into a hidden memory space for a computer platform, the computer platform including an extended memory mode processor that supports execution of 32-bit and 64-bit instructions; and
in response to a system management event;
executing at least one of the 32-bit and 64-bit event handlers to service the system management event.

15. The method of claim 14, further comprising:
switching the processor into a 32-bit execution mode; and
dispatching at least one 32-bit handler in an attempt to service the event.

16. The method of claim 15, wherein said at least one 32-bit handler that was launched was not a proper handler for handling the event, the method further comprising:
switching the processor into a 64-bit execution mode; and
dispatching at least one 64-bit handler to service the event.

17. The method of claim 14, further comprising:
switching the processor to its 64-bit execution mode; and
dispatching at least one 64-bit handler in an attempt to service the event.

18. The method of claim 17, wherein said at least one 64-bit handler that was launched was not a proper handler for handling the event, the method further comprising:
switching the processor mode to a compatibility mode; and
dispatching at least one 32-bit handler to handle the event, said at least one 32-bit handler being executed while in the compatibility mode.

19. A method for extending a System Management Mode (SMM) of a computer platform microprocessor supporting a 64-bit extended memory execution mode, comprising:
publishing an interface during a pre-boot process for the computer system to enable a driver that is stored outside of components in which an original set of platform firmware is stored to provide a set of machine code comprising a 64-bit event handler that is loaded into system management random access memory (SMRAM) during the pre-boot process;
switching the microprocessor to a 64-bit execution mode in response to an SMM triggering event; and
executing the event handler to service the SMM triggering event.

20. The method of claim 19, further comprising:
loading an event handler management service into SMRAM;
registering one or more 64-bit event handlers with the event handling management service;
loading said one or more 64-bit event handlers into SMRAM;
redirecting an instruction pointer for the microprocessor to begin execution of the event handler management service is response to the SMM triggering event; and
dispatching a 64-bit event handler via the event handler management service to service the event.

21. The method of claim 20, wherein a plurality of event handlers are registered with the event handling management service and loaded into SMRAM, further comprising:
creating an ordered list of said plurality of 64-bit event handlers;
dispatching a first 64-bit event handler;
determining if the first 64-bit event handler is an appropriate event handler for servicing the SMM triggering event and, if it is, executing the first 64-bit event handler to completion to service the event; otherwise
dispatching a next 64-bit event handler in the list and determining whether that event handler is an appropriate event handler for servicing the SMM triggering event and repeating this function until the appropriate 64-bit vent handler has been dispatched, whereupon that event handler is executed to completion to service the SMM triggering event.

22. The method of claim 19, further comprising:
registering one or more legacy event handlers with the event handling management service, each legacy event handler comprising 32-bit code;
loading said one or more legacy event handlers into SMRAM; and
dispatching at least one of said one or more legacy event handlers via the event handler management service to service the SMM triggering event.

23. The method of claim 19, further comprising:
scanning for any firmware volumes that are materialized during the pre-boot process for the computer system to identify an existence of any firmware file containing a 64-bit event handler;
loading the event handler into SMRAM; and
executing the event handler to service the SMM triggering event.

24. A machine-accessible medium, to provide instructions that if executed on a computer platform having a 64-bit extended memory mode processor that supports execution of 32-bit and 64-bit code perform operations comprising:
providing a mechanism to enable loading of one or more 64-bit event handlers into a hidden memory space for the computer platform; and
in response to a system management event;
switching the processor into a 64-bit execution mode; and
dispatching one of said one or more 64-bit event handlers for execution to service the system management event.

25. The machine-accessible medium of claim 24, wherein execution of the instructions performs further operations including:
switching the processor into a processing mode that supports execution of 32-bit code; and
dispatching one or more 32-bit event handlers for execution in that processing mode.

26. The machine-accessible medium of claim 24, wherein execution of the instructions performs further operations including:
publishing an interface to enable registration of said one or more 64-bit event handlers with a system management framework employed to manage service of system management events;
building a list of 64-bit event handlers that are registered via the interface; and
dispatching the 64-bit event handlers that are registered in order based on the list.

27. The machine-accessible medium of claim 26, further comprising:
enabling registration of one or more 32-bit event handlers via the interface;
building a list of 32-bit event handlers that are registered via the interface; and
dispatching the 32-bit event handlers that are registered in order based on the list.

28. A computer platform, comprising:
a motherboard;
a processor supporting a 64-bit extended memory mode, coupled to the motherboard;
memory, operatively-coupled to the motherboard and communicatively-coupled to the processor; and
a flash device, mounted to the motherboard and communicatively-coupled to the processor via the motherboard, having firmware instructions stored thereon, which if executed by the processor perform operations including,
partitioning a portion of the memory into system management random access memory (SMRAM) comprising a hidden memory space;
providing a mechanism to enable loading of one or more 64-bit event handlers into SMRAM; and
in response to a system management event;
switching the processor into a 64-bit execution mode; and
dispatching one of said one or more 64-bit event handlers for execution to service the system management event.

29. The computer platform of claim 28, wherein execution of the firmware instructions performs further operations including:
publishing an interface during a pre-boot process for the computer platform to enable a driver that is stored outside of the flash device to provide a set of machine code comprising a 64-bit event handler that is loaded into SMRAM during the pre-boot process.

30. The computer platform of claim 29, wherein execution of the firmware instructions performs further operations including:
loading an event handler management service into SMRAM;
registering one or more 64-bit event handlers with the event handling management service;
loading said one or more 64-bit event handlers into SMRAM;
redirecting an instruction pointer for the processor to begin execution of the event handler management service is response to the system management event; and
dispatching a 64-bit event handler via the event handler management service to service the event.
